(19) United States
(12) Patent Application Publication
(10) Pub. No.: US 2024/0310831 A1
(43) Pub. Date: Sep. 19, 2024

(54) VEHICLE BASED OPERATOR PRESENCE CONTROL FOR SUPERVISED PARTIALLY AUTONOMOUS VEHICLE APPLICATIONS

(71) Applicant: GM GLOBAL TECHNOLOGY OPERATIONS LLC, Detroit, MI (US)

(72) Inventors: Malek JARADI, Troy, MI (US); David T. Proefke, Troy, MI (US); Grant L. Meade, Whitby (CA)

(21) Appl. No.: 18/123,074

(22) Filed: Mar. 17, 2023

(51) Int. Cl. G05D 1/00; B60W 30/06; B60W 60/00

(52) U.S. Cl. CPC G05D 1/0016; B60W 30/06; B60W 60/00; B60W 2756/10

(57) ABSTRACT

A vehicle system is disclosed and includes: a transceiver; a vehicle module configured to execute a supervised partially autonomous application (SPAA) at a vehicle; a user interface system configured to receive an input from a user to initiate a supervised remote mode for user presence control during execution of the SPAA; and a user presence module configured, until SPAA operations are ceased or completed, to perform a user presence process including iteratively i) transmitting a challenge request signal from the vehicle to a mobile smart device via the transceiver, ii) based on the challenge request signal, receiving a response signal from the mobile smart device indicating a user response provided to the mobile smart device, iii) based on the response signal, confirming user presence and whether the user response is valid for continued execution of operations of the SPAA, and iv) based on validation of the user response, performing a next operation of the SPAA.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to supervised partially autonomous vehicle applications.

A partially or fully autonomous vehicle performs certain operations without driver intervention. For example, an autonomous vehicle may perform adaptive cruise control operations, lane-keeping operations, parking operations, etc. without user intervention. This may include autonomously controlling vehicle steering, braking, accelerating, and decelerating. The operations are performed by one or more vehicle controllers and actuators based on feedback from vehicle sensors.

### SUMMARY

A vehicle system is disclosed and includes: a transceiver; a vehicle module configured to execute a supervised partially autonomous application (SPAA) at a vehicle; a user interface system configured to receive an input from a user to initiate a supervised remote mode for user presence control during execution of the SPAA; and a user presence module configured, until SPAA operations are ceased or completed, to perform a user presence process including iteratively i) transmitting a challenge request signal from the vehicle to a mobile smart device via the transceiver, ii) based on the challenge request signal, receiving a response signal from the mobile smart device indicating a user response provided to the mobile smart device, iii) based on the response signal, confirming user presence and whether the user response is valid for continued execution of operations of the SPAA, and iv) based on validation of the user response, performing a next operation of the SPAA.

In other features, the user presence module is configured, subsequent to initiating operation in the supervised remote mode and prior to performing operations of the SPAA, to perform a confirmation process including i) transmitting a second challenge request signal to the mobile smart device for confirmation to execute the SPAA, ii) based on the second challenge request signal, receiving another response signal from the mobile smart device indicating a user response provided to the mobile smart device, iii) based on the another response signal, confirming user presence and whether the user response is valid to execute the SPAA, and iv) based on validation of the user response, at least one of performing an operation of the SPAA and performing the user presence process.

In other features, the user presence module is configured to: start a timer when the second challenge request signal is transmitted to the mobile smart device; in response to the timer timing out prior to user presence being confirmed and the user response being validated to execute the SPAA, refraining from performing operations of the SPAA; and in response to confirming user presence and validation of the user response to execute the SPAA, permitting performance of operations of the SPAA.

In other features, the user presence module is configured, subsequent to initiating operation in the supervised remote mode and prior to performing operations of the SPAA, to perform a confirmation process including i) transmitting a confirmation request signal to the mobile smart device for confirmation to execute the SPAA, ii) based on the confirmation request signal, receiving another response signal from the mobile smart device indicating a user response has been received at the mobile smart device and the user response has been validated for execution of the SPAA, and iii) based on the another response signal, at least one of performing an operation of the SPAA and performing the user presence process.

In other features, the user presence module is configured to: start a timer when the confirmation request signal is transmitted to the mobile smart device; in response to the timer timing out prior to receiving confirmation from the mobile smart device to execute the SPAA, refrain from performing operations of the SPAA; and in response to receiving confirmation from the mobile smart device to execute the SPAA, permit performance of operations of the SPAA.

In other features, the user presence process is performed subsequent to initiation of the supervised remote mode and subsequent to detecting that the user has exited the vehicle.

In other features, the challenge request signal includes a request for the user to at least one of provide a gesture, perform a physical action, provide an audible input, answer a question, and perform a requested task including interaction with the mobile smart device.

In other features, the SPAA is at least one of a supervised remote parking application, a supervised remote liftgate application, a supervised remote tailgate application, a supervised remote convertible top application, and supervised remote safety critical application.

In other features, the user presence module is configured to: start a timer when the challenge request signal is transmitted to the mobile smart device; in response to the timer timing out prior to user presence being confirmed and the user response being validated, refrain from performing operations of the SPAA; and in response to confirming user presence and validation of the user response, permit performance of operations of the SPAA.

In other features, the vehicle module is configured to, during at least one of confirmation to execute the SPAA and execution of the SPAA, ignore signals received from a second mobile smart device paired with the vehicle that are directed to the SPAA.

In other features, a mobile smart device is disclosed and includes: a transceiver configured to receive challenge request signals from a vehicle for performing operations of a supervised partially autonomous application (SPAA) at the vehicle; and a control module configured to perform an iterative transfer process for validation of user responses to the challenge request signals. The iterative transfer process includes iteratively: based on a respective one of the challenge request signals, indicating a challenge request to a user of the mobile smart device; detecting a user response to the challenge request, and transmitting a response signal indicating the user response to the vehicle without validating the user response for continued execution of the SPAA.

In other features, the control module is configured to, prior to performing the iterative transfer process: receive another challenge request signal from the vehicle requesting confirmation to execute the SPAA; based on the another challenge request signal requesting confirmation to execute the SPAA, indicate a challenge request to the user; detect a user response to the another challenge request signal requesting confirmation to execute the SPAA; and transmit a response signal indicating the user response to the vehicle without validating the user response for continued execution of the SPAA.

In other features, the mobile smart device further includes sensors for detecting the user responses to the challenge requests. The sensors are configured to detect at least one of physical actions taken by the user to provide the user response, audible actions taken by the user to provide the user response, and input responses provided by the user to provide the user response.

In other features, the control module is configured to, prior to performing the iterative transfer process: receive a confirmation request signal from the vehicle requesting confirmation to execute the SPAA; based on the confirmation request signal requesting confirmation to execute the SPAA, request confirmation from the user to execute the SPAA; detect a user response to the request; confirm that the user response to the request is valid; and transmit a response signal indicating that a user response has been received and validated for confirmation to execute the SPAA.

In other features, a user presence control method is disclosed and includes: receiving an input from a user within a vehicle to initiate a supervised remote mode for user presence control during execution of a supervised partially autonomous application (SPAA); and, until SPAA operations are ceased or completed, to perform a user presence process including iteratively i) transmitting a challenge request signal from the vehicle to a mobile smart device via a transceiver, ii) based on the challenge request signal, receiving a response signal from the mobile smart device at the vehicle indicating a user response provided to the mobile smart device, iii) based on the response signal, confirm user presence and whether the user response is valid for continued execution of operations of the SPAA, and iv) based on validation of the user response, perform a next operation of the SPAA.

In other features, the user presence control method further includes, subsequent to initiating operation in the supervised remote mode and prior to performing operations of the SPAA, performing a confirmation process including i) transmitting a second challenge request signal to the mobile smart device for confirmation to execute the SPAA, ii) based on the second challenge request signal, receiving another response signal from the mobile smart device indicating a user response provided to the mobile smart device, iii) based on the another response signal, confirming user presence and whether the user response is valid to execute the SPAA, and iv) based on validation of the user response, at least one of performing an operation of the SPAA and performing the user presence process.

In other features, the user presence control method further includes: starting a timer when the second challenge request signal is transmitted to the mobile smart device; in response to the timer timing out prior to user presence being confirmed and the user response being validated to execute the SPAA, refraining from performing operations of the SPAA; and in response to confirming user presence and validation of the user response to execute the SPAA, permitting performance of operations of the SPAA.

In other features, the user presence control method further includes, subsequent to initiating operation in the supervised remote mode and prior to performing operations of the SPAA, performing a confirmation process including i) transmitting a confirmation request signal to the mobile smart device for confirmation to execute the SPAA, ii) based on the confirmation request signal, receiving another response signal from the mobile smart device indicating a user response has been received at the mobile smart device and the user response has been validated for execution of the SPAA, and iii) based on the another response signal, at least one of performing an operation of the SPAA and performing the user presence process.

In other features, the user presence control method further includes: starting a timer when the confirmation request signal is transmitted to the mobile smart device; in response to the timer timing out prior to receiving confirmation from the mobile smart device to execute the SPAA, refraining from performing operations of the SPAA; and in response to receiving confirmation from the mobile smart device to execute the SPAA, permitting performance of operations of the SPAA.

In other features, the SPAA is a supervised remote parking application, a liftgate application, a tailgate application, or a convertible top application.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example supervised remote parking system including a vehicle with a user presence module and a mobile smart device in accordance with the present disclosure;

FIG. 2 is a functional block diagram of the vehicle including a user interface and presence control system including the user presence module in accordance with the present disclosure;

FIG. 3 is a functional block diagram of the mobile smart device including a challenge request transfer module in accordance with the present disclosure;

FIG. 4 is a front view of an example mobile smart device illustrating an example challenge request;

FIG. 5 is a front view of an example mobile smart device illustrating another example challenge request;

FIGS. 6A-6B illustrate an example presence control method implemented by the vehicle of FIGS. 1-2 in accordance with the present disclosure;

FIG. 7 illustrates an example challenge request transfer method implemented by the mobile smart device of FIGS. 1 and 3 in accordance with the present disclosure.

In the drawings, reference numbers may be reused to identify similar and/or identical elements.

### DETAILED DESCRIPTION

Supervised partially autonomous vehicle applications, such as supervised remote parking, can include a user (or vehicle operator) supervising operation of a vehicle using a mobile phone while the user is outside of the vehicle. Supervised remote parking is used, for example, when a user realizes that a parking space is too narrow for the user to be able to open a vehicle door and exit the vehicle. The user initiates supervised remote parking and performs a “handoff” while the user is within the vehicle. This transfers interaction with the user from the vehicle to the mobile phone by initiating supervisory control for the user at the mobile phone. The user exits the vehicle and the mobile phone requests input from the user to assure that the user is present and confirms continued implementation of parking operations. The mobile phone may request for example that the user continue to slide a finger across the screen of the mobile phone and the mobile phone validates that the user is providing the request and continued input. The mobile phone signals the vehicle that the user has provided the correct and continued input and the vehicle continues performing the parking operations until the vehicle is parked. The vehicle is only informed of whether the user inputs have been validated by the mobile phone.

A problem with relying on user input processing within a mobile phone to supervise an operation requested by a mobile phone is that the operating system of the mobile phone may exhibit a fault or a failure mode. For example, an issue can arise during supervised remote parking of a vehicle when a mobile phone incorrectly interprets and falsely validates user inputs and indicates to the vehicle that challenge requests have been satisfied. As an example, if the display of the mobile phone is wet, degraded and/or is operating inappropriately, the mobile phone may falsely validate a received input when in actuality the received input was improper. The mobile phone may ask the user, as part of a challenge request, to slide a finger between two points on the display and the user may have instead touched the two points or points near the stated two points. Because the mobile phone incorrectly detected the user's actions, the mobile phone determines that the user provided the requested input. This would result in the mobile phone reporting to the vehicle that the correct input was received and the vehicle can continue performing the parking operations.

The examples set forth herein include systems and methods for implementing operator presence control during execution of supervised partially autonomous vehicle applications. This includes i) a vehicle (referred to as the “Requestor”) generating challenge requests for the operator to perform one or more specific actions involving interaction with a mobile smart device, ii) sending the challenge requests to the mobile smart device, and iii) the vehicle confirming and/or validating operator responses to the challenge requests at the vehicle based on signals received from the mobile smart device indicating operator responses to the challenge requests. In an embodiment, the mobile smart device does not confirm and/or validate the operator responses but rather performs as a passthrough device and i) provides the challenge requests to the operator, and ii) relays inputs received from the operator and related information to the vehicle. The vehicle then determines whether the operator satisfied the challenge requests. The vehicle processes, confirms and validates user inputs that were received at the mobile smart device and transferred to the vehicle. This may include determining whether the inputs are timely. As a result, end-to-end integrity is preserved. In an embodiment, the mobile smart device does not perform the confirmation and/or validation of the operator responses.

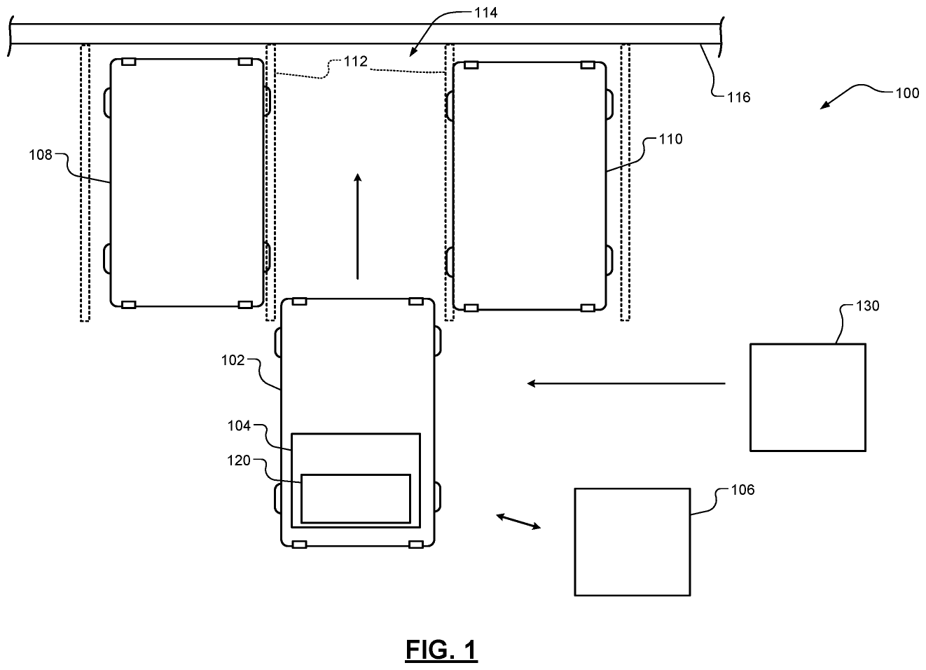

FIG. 1 shows a supervised remote parking system 100 including a vehicle 102 with a vehicle control module 104 and a mobile smart device 106. The vehicle control module 104 may execute a supervised partially autonomous application (SPAA) such as a supervised remote parking application to park the vehicle 102 between vehicles 108, 110. Other SPAAs are described below. In the example shown, the vehicles 108, 110 parked on or over parking space lines 112 of an empty parking space 114. The parking space lines 112 may extend from a fixed structure (e.g., a wall or rail) 116. Due to the encroaching and/or closely parked vehicles 108, 110, there is not enough room for a vehicle operator (or user) of the vehicle 102 to exit the vehicle 102 once the vehicle 102 is parked in the parking space 114.

Implementing the supervised remote parking application allows the user to exit the vehicle 102 and perform supervised remote parking via the mobile smart device 106. Before exiting the vehicle, the user may initiate a supervised remote mode. The supervised remote mode is initiated by handing off user interaction from being between the user and the vehicle 102 to being between the user and the mobile smart device 106. During the supervised remote mode, user presence is detected and user responses to challenge requests are validated for continued implementation of operations of a SPAA. The vehicle control module 104 may indicate that the supervised remote mode is available for parking and receive an input from the user to initiate supervised remote parking. The vehicle control module 104 then performs a handoff to the mobile smart device 106 to transfer interaction with the user from the vehicle to the mobile smart device.

A user presence module 120 performs user presence operations to confirm that the user still wants the vehicle to be parked after the user exits the vehicle and/or to validate user responses to challenge requests for continued implementation of the supervised remote parking application. The user presence module 120 may send a challenge request to the mobile smart device 106 after the user exits the vehicle 102 to confirm that the user is ready for and agrees with the vehicle 102 being parked. The user presence module 120 receives a response signal from the mobile smart device 106 indicating a user response to the challenge request and determines whether the user response is correct. If correct, the user presence module 120 continues with remote parking operations.

The remote parking operations include continuously or periodically providing challenge requests to the user via the mobile smart device 106 and continuing parking operations as long as the user continues to provide the correct expected responses. Validation of the user's responses occurs at the vehicle 102 by the user presence module 120. This provides continued user presence control. If the user does not respond to a challenge request and/or provides an incorrect response, the user presence module 120 interrupts the remote parking operations being performed by the vehicle control module 104 and the vehicle 102 is in an at rest (non-moving) state. The default state of the vehicle 102 is an at rest state. The vehicle continues to move to parked location only when the user continues to provide correct input responses (e.g., continuing to slide a finger in a circle on a screen of the mobile smart device 106) to the mobile smart device 106. In an embodiment, the user must continue to provide input until the user wants vehicle to stop performing SPAA operations or SPAA operations are completed for the particular SPAA being implemented.

The user presence module 120 may provide various different types of challenge requests. The challenge requests may include requests for the user to perform specific actions, such as: provide a certain gesture; tap on the display of the mobile smart device 106 a certain number of times and/or in a certain pattern; sliding a finger across and/or in a certain pattern on the display of the mobile smart device 106; verbal responses; motion responses of the mobile smart device 106 (i.e., movement of the mobile smart device 106 in a certain manner); etc. A gesture may include contact by the user's hand and the display of the mobile smart device 106, or include a non-contacting gesture such as a hand wave and/or other gesture. The challenge requests may be time based, where a user is asked to perform one or more tasks in one or more certain periods of time. The challenge requests may include the user answering questions.

The vehicle control module 104 and the user presence module 120 perform operations for a SPAA based on responses from a driving mobile smart device, not from other mobile smart devices in the area. For example, two mobile smart devices (e.g., the mobile smart device 106 and mobile smart device 130) may have been paired with the vehicle 102 prior to initiation of the supervised remote parking application. The two mobile smart devices may be removed from the vehicle 102 and may continue communicating with the vehicle 102. The modules 104, 120 may ignore signals from the mobile smart device 130 with respect to performing supervised remote parking operations. In this example, the mobile smart device 106 is referred to as the “initiating” and/or “driving” device with respect to the supervised remote parking application. The vehicle control module 104 may identify the mobile smart devices 106, 130 based on mobile smart device specific signatures, security keys, passwords, and/or other identifiers and, based on one or more of these identifiers, perform operations related to SPAA based on signals from the mobile smart device 106 and not based on signals from the mobile smart device 130.

The vehicle 102, the mobile smart device 106, and the modules 104, 120 and operations thereof are further described below.

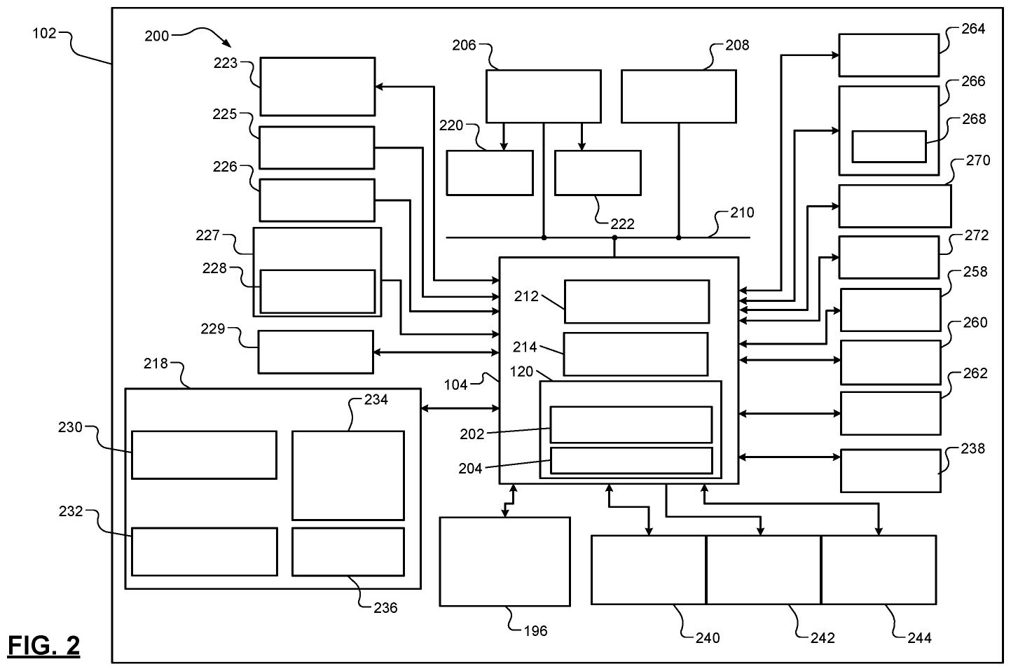

FIG. 2 shows the vehicle 102 including a user interface and presence control system 200 including the modules 104, 120. The user presence module 120 may include an initial confirmation module 202 and a validation module 204. The initial confirmation module 202 may initiate operations of a challenge-transfer-receive-validate procedure (or user presence procedure) described herein. This includes the initial confirmation module 202 generating a challenge request, sending the challenge request to a mobile smart device, receiving a response signal from the mobile smart device including information indicating a user response, and validating the user response at the vehicle 102. The validation module 204 may iteratively perform the user presence procedure for continued performance of a SPAA and operations thereof. Operations of the modules 202, 204 are further described below.

The vehicle 102 includes the vehicle control module 104, an infotainment module 206 and other control modules 208. The modules 202, 204, 206, 208 may communicate with each other via one or more buses 210, such as a controller area network (CAN) bus and/or other suitable interfaces. The vehicle control module 104 may control operation of vehicles systems and include a mode selection module 212, a parameter adjustment module 214, as well as other modules. The mode selection module 212 may select a vehicle operating mode, such as the supervised remote mode. The parameter adjustment module 214 may adjust various parameters of the vehicle 102.

The vehicle 102 may further include: a memory 218; a display 220; an audio system 222; one or more transceivers 223; input devices 225; sensors 226; a navigation system 227 including a global positioning system (GPS) receiver 228; and a microphone 229. The input devices may include buttons, switches, dials, etc. The sensors 226 may include temperature and pressure sensors, accelerometers, a vehicle velocity and/or speed sensor, air flow sensors, interior and exterior cameras, radar sensors, and/or other sensors. The cameras may be used to monitor and/or detect actions of vehicle occupants. The GPS receiver 228 may provide vehicle velocity and/or direction (or heading) of the vehicle and/or global clock timing information. The microphone may be used to detect verbal commands and/or responses from vehicle occupants.

The memory 218 may store sensor data 230, parameters 232, supervised partially autonomous applications 234, and other applications 236. The supervised partially autonomous applications 234 may include a supervised remote parking application, a supervised remote liftgate application, a supervised remote tailgate application, a supervised remote convertible top application, a supervised remote safety critical application, and/or other application that utilizes remote user presence control of vehicle operations.

The supervised remote parking applications may include a user enabling parking the vehicle 102 and/or removing the vehicle 102 from a parking spot based on supervised input responses to challenge requests as performed at a mobile smart device and validated at the vehicle 102 via the user presence module 120. The supervised remote liftgate application may include a user enabling vehicle opening (i.e., lifting) or closing a liftgate of the vehicle 102 based on supervised input responses to challenge requests as performed at a mobile smart device and validated at the vehicle 102 via the user presence module 120. The supervised remote tailgate application may include a user enabling vehicle to open or close a tailgate of the vehicle 102 based on supervised input responses to challenge requests as performed at a mobile smart device and validated at the vehicle 102 via the user presence module 120. The supervised remote convertible top application may include a user enabling vehicle to open or close a convertible top of the vehicle 102 based on supervised input responses to challenge requests as performed at a mobile smart device and validated at the vehicle 102 via the user presence module 120. A user may be out of the vehicle 102 and within monitoring range of the vehicle 102 while providing supervised remote control via the mobile smart device 106.

The applications 236 may include applications executed by the modules 104, 206, 208. Although the memory 218 and the vehicle control module 104 are shown as separate devices, the memory 218 and the vehicle control module 104 may be implemented as a single device.

The vehicle control module 104 may include or have access to one or more timers 238. The timers 238 may be used to determine whether confirmation for execution of SPAAs and/or validation of user presence and continued performance of SPAA operations has occurred, as further described below.

The vehicle control module 104 may control operation of an engine 240, a converter/generator 242, a transmission 244, a brake system 258, electric motors 260, a steering system 262, window and door motors 264, lighting system 266, liftgate or tailgate motor 270, and/or convertible top motor 272 according to parameters set by the modules 202, 204, 206, 208. The vehicle control module 104 may set some of the parameters based on signals received from the sensors 226. The vehicle control module 104 may receive power from a power source 196, which may be provided to the engine 240, the converter/generator 242, the transmission 244, the brake system 258, the electric motors 260, the steering system 262, window and door motors 264, lighting system 266, liftgate or tailgate motor 270, and/or convertible top motor 272. Some of the vehicle control operations may include enabling fuel and spark of the engine 240, starting the electric motors 260, powering any of the systems 222, 227, 258, 262, and/or performing other operations as are further described herein.

The engine 240, the converter/generator 242, the transmission 244, the brake system 258, the electric motors 260 and/or the steering system 262 may include actuators controlled by the vehicle control module 104 to, for example, adjust fuel, spark, air flow, motor speed, motor output torque, engine output torque, steering wheel angle, throttle position, accelerator pedal position, etc. This control may be based on the outputs of the sensors 226, the navigation system 227, the GPS receiver 228 and the above-stated data and information stored in the memory 218.

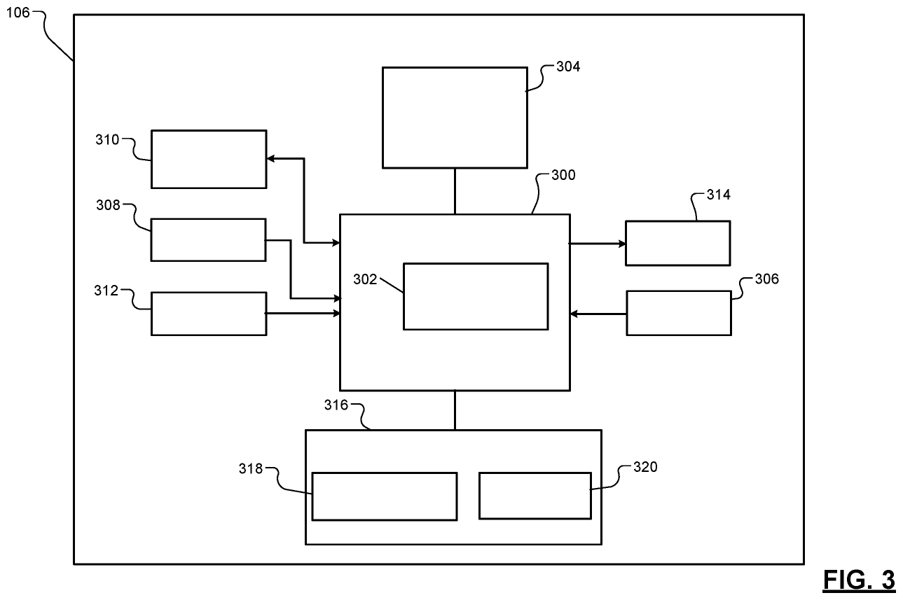

FIG. 3 shows the mobile smart device 106 including a control module 300 with a challenge request transfer module 302. The mobile smart device 106 may be a mobile phone, a smart watch or other smart wearable device, a tablet, a key fob, a personal assistant device, etc. Although the mobile smart device 106 is described as having certain features, one or more of the features may not be included. The challenge request transfer module 302 may receive challenge requests from a vehicle and transfer user responses to the challenge requests back to the vehicle. The challenge request transfer module 302 indicates the received challenge requests to a user via, for example, a display 304 and receives users responses to the challenge requests via the display 304, a microphone 306, and/or other sensors 308 such as a camera and/or an accelerometer. The camera may be used to detect movement by the user, a hand gesture by the user, etc. The accelerometer may be used to detect movement of the mobile smart device 106. For example, a challenge request may request a user to wave, tilt or shake the mobile smart device 106, etc., which may be detected by the camera and/or accelerometer. The display 304 may be a touch screen for receiving input responses.

The mobile smart device 106 may further includes one or more transceivers 310 for communicating with a vehicle, a GPS receiver 312, one or more speakers 314, and memory 316. The memory 316 may store sensor data 318 and applications 320. The sensor data may include raw data, filtered data, and/or translated data. The raw data is data received directly from sensors without filtering and/or processing. The filtered data may be low pass, bandpass, and/or high pass filtered sensor data. The translated data may be processed data that is able to be interpreted by the vehicle. The challenge request transfer module may transfer the raw data, the filtered data, and/or the translated (or processed) data to the vehicle via the one or more transceivers 310. The stated data may indicate actual physical and/or audible actions performed by the user including actual screen positions where the user touched, durations of touch, timing of touches, answers to questions, patterns drawn on display 304, physical movements of user as detected by one of the cameras of the sensors 308, audible responses, movements of the mobile smart device 106, etc.

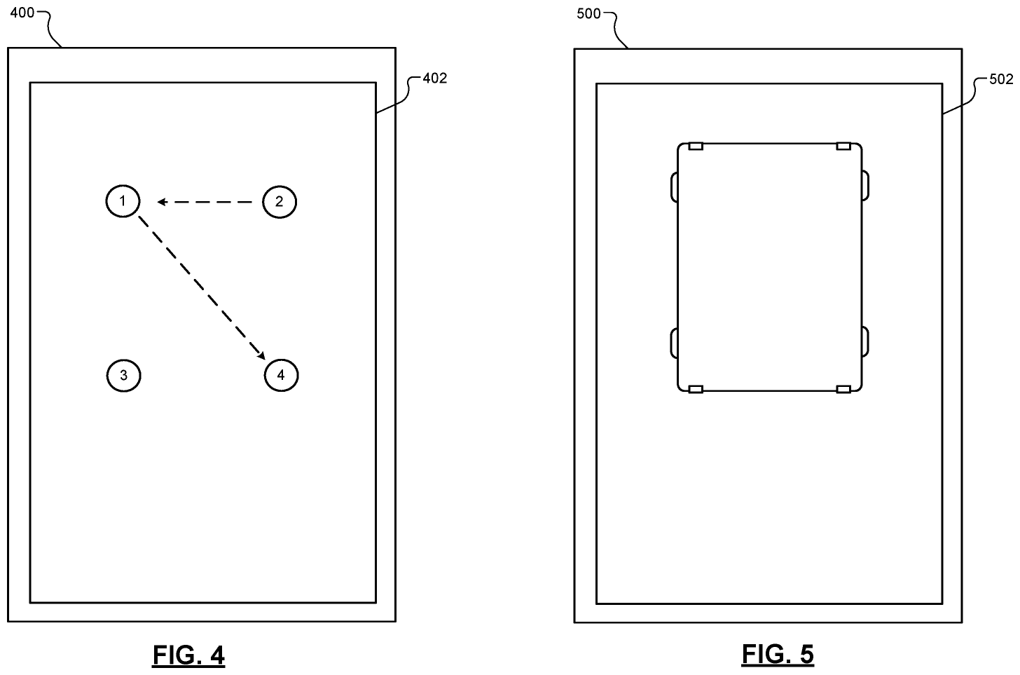

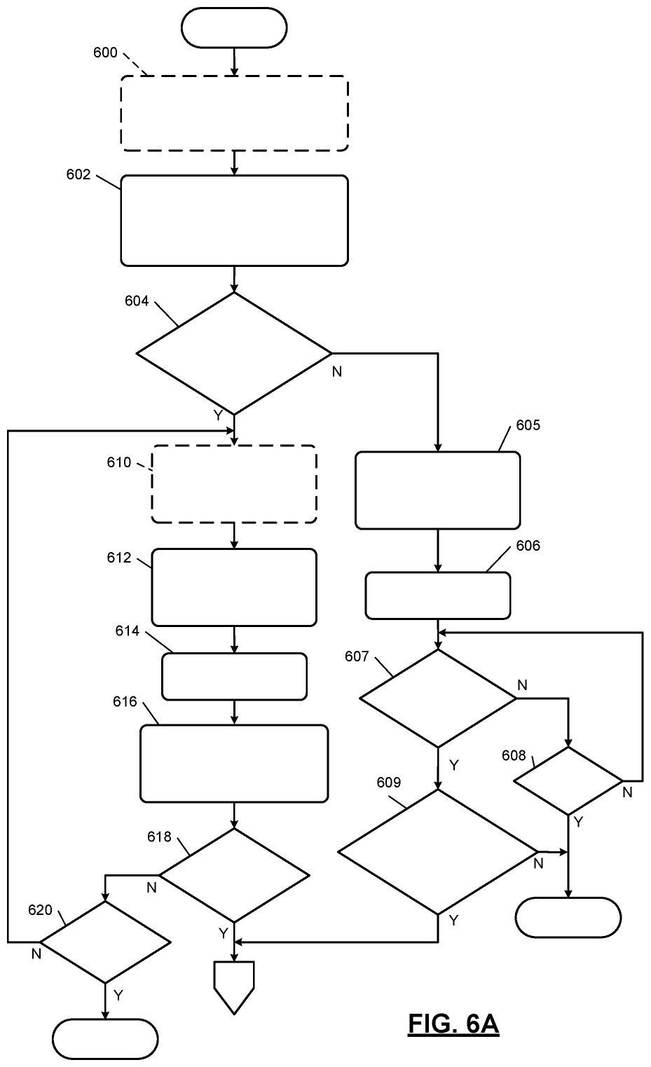

FIGS. 4-5 provide a couple different example challenge requests. Numerous other challenge requests may be implemented. The vehicle control module 104 of FIG. 2 may provide one or more challenge requests during execution of a SPAA. The challenge requests may periodically change to further assure that the user remains present and agrees with continued performance of SPAA operations.

FIG. 4 shows a mobile smart device 400 illustrating an example challenge request. The mobile smart device 400 may be configured similarly as the mobile smart device 106 of FIG. 3. The mobile smart device 400 includes a display 402. In the example shown, the mobile smart device 400 is providing a challenge request to a user. The challenge request and other challenge requests may be received from the vehicle 102. The mobile smart device 400 may prompt the user for input to be taken within a predetermined timeframe. The challenge request requests the user to perform one or more actions such as to move a finger to a relative display position, move a finger to a requested number on the display 402, make a specific pattern on the display 402, confirm a particular vehicle behavior, etc. In the example shown, the challenge request requests that the user slide a finger on the display 402 between certain displayed points. The user may then satisfy this request. The mobile smart device 400 may then send a response signal to a vehicle (e.g., the vehicle 102 of FIG. 2) indicating the user's response. The signal may include indications where the user touched the display 402, durations of touch by the user on the display 402, durations of other actions performed by the user, order in which the user actions were performed, etc. The vehicle 102 may then determine whether the user's actions satisfy the challenge request.

As another example, the mobile smart device 400 may instruct the user to press #1 at “top left”, shift finger to “bottom right” and press #3. The vehicle 102 may then determine based on received inputs, as indicated by the mobile smart device 400 to the vehicle 102, whether: the user satisfied these commands; performed these commands within a predetermined period of time; pressed the correct numbered points at the correct times; and/or pressed the correct numbered points for the correct duration of time. Thus, durations of points touched, durations between touched points, timing of each touch, etc. may be monitored to determine whether the user's response is valid.

FIG. 5 shows a mobile smart device 500 illustrating another example challenge request. The mobile smart device 500 may be configured similarly as the mobile smart device 106 of FIG. 3. The mobile smart device 500 includes a display 502. In the example shown, the mobile smart device 500 is providing a challenge request to a user. The challenge request and other challenge requests may be received from the vehicle 102. The challenge request requests the user to touch a light displayed on the display 502 as part of an image of the vehicle 102 that is lit up. The user may then look at the vehicle 102, see which light on the vehicle 102 is lit up, and touch the corresponding light on the display 502 to satisfy this request. The mobile smart device 400 may then send a response signal to a vehicle (e.g., the vehicle 102 of FIG. 2) indicating the user's response. The signal may include an indication where the user touched the display 502. The vehicle 102 may then determine whether the user's action satisfies the challenge request.

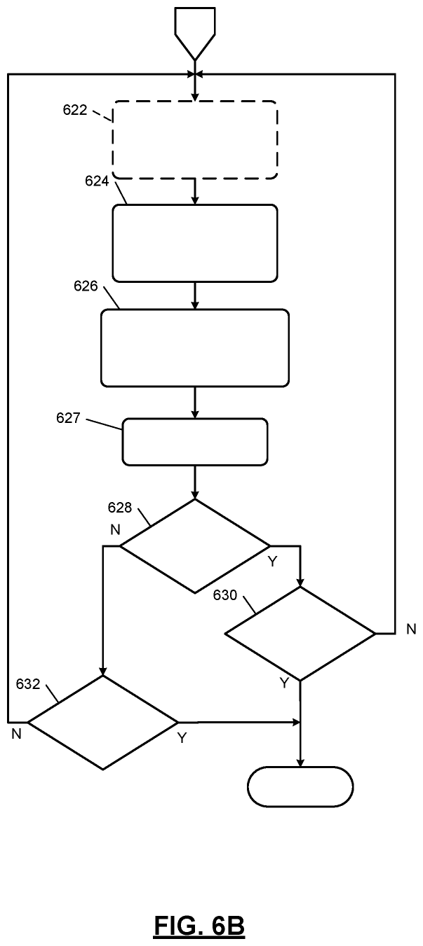

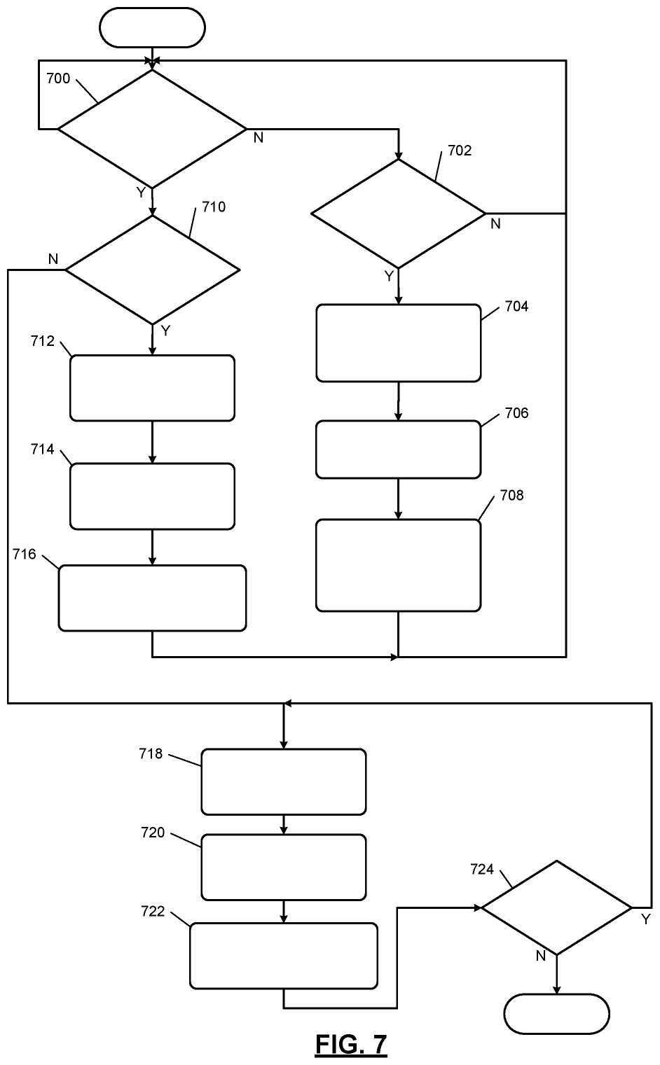

FIGS. 6A-6B shows a presence control method implemented by the vehicle 102 of FIGS. 1-2. The method of FIGS. 6A-6B, collectively FIG. 6, may be implemented while the method of FIG. 7 is implemented. The following operations of FIG. 6 may be implemented by one or more of the modules 104, 120, 202, 204 of FIGS. 1-2. At least a portion of the operations are iteratively performed.

At 600, the vehicle control module 104 may indicate within the vehicle 102 that the supervised remote mode is available for a particular SPAA. This may include, for example, displaying on the display 220 an indication that supervised remote mode is available for the SPAA. For example, the vehicle control module 104 may detect that a parking space is available and indicate that the supervised remote mode may be enabled to perform the supervised remote parking application.

At 602, the vehicle control module 104 may receive an input from a user within the vehicle 102 to initiate a handoff for supervised remote mode for implementation of the SPAA. This transfers interaction with the user to be between the user and the mobile smart device 106. The mobile smart device 106 being a device paired for communication with the vehicle.

At 604, the vehicle control module 104 determines whether to perform user presence operations for the initial confirmation. When the user initially exits the vehicle a confirmation is obtained from the user to confirm that the user wants to execute the SPAA. This may be accomplished using user presence operations (e.g., operations 610, 612, 614, 616, 618, 620) or may be accomplished by having the mobile smart device 106 interact with the user and confirm that the user wants to continue. This may be done via operations 605-609. In an embodiment, the vehicle control module 104 may detect locations of the user and/or the mobile smart device to determine if the user has exited the vehicle 102. This may be based on outputs of sensors, such as cameras internal to and/or external to the vehicle 102, transmission of signals between transceivers of the vehicle 102 and the mobile smart device 106, etc. For example, the vehicle control module 104 may perform triangulation based on locations of transceivers, travel times of signals, etc. to detect the location of the mobile smart device. User presence operations may be performed subsequent to the user exiting the vehicle 102.

At 605, one or more of the modules 104, 120 may send a signal to the mobile smart device 106 to obtain confirmation to continue. Operations 700, 702, 704, 706, 708 of FIG. 7 may then be performed by the mobile smart device 106.

At 606, one or more of the modules 120, 202 may initiate a first timer if not already started.

At 607, one or more of the modules 120, 202 determines whether a response has been received from the mobile smart device 106. If no, operation 608 may be performed, otherwise operation 609 may be performed.

At 608, one or more of the modules 120, 202 may determine whether the first timer has exceeded a threshold (i.e., timed out). If yes, the method may end, otherwise operation 607 may be performed.

At 609, one or more of the modules 120, 202 determines whether a confirmation response signal has been received from the mobile smart device 106 indicating that the user has confirmed performing the SPAA. The mobile smart device 106 validated a response from the user prior to generating the confirmation response signal. Operation 622 may be performed subsequent to operation 609.

At 610, one or more of the modules 120, 202 may perform a vehicle operation that can be detected by the user, such as turn on and/or blink one or more lights, make one or more audible sounds, display an image on the display 220, etc. This vehicle operation may be done as part of a user challenge and in response to which the user will be requested to provide an input response. In an embodiment, operation 610 is not performed and operation 612 is performed instead.

At 612, one or more of the modules 120, 202 sends a challenge request from the vehicle 102 to the mobile smart device 106. Operations 700, 710, 712, 714, 716 may then be performed by the mobile smart device 106.

At 614, one or more of the modules 120, 202 may initiate a first timer if not already started.

At 616, one or more of the modules 120, 202 receives a response signal indicating a user input response and details thereof. This may include raw sensor data, filtered sensor data, and/or translated (or processed) sensor data. This data may include information indicating any of the information described herein regarding the user inputs received. The information may include the types of inputs received, the durations of the inputs, the timing of the inputs, etc.

At 618, one or more of the modules 120, 202 determines, based on the response signal including the user input response and details thereof, whether the user's response is valid. If the received data does not match the expected response for continuing operations for the SPAA, then operation 618 may be performed, otherwise operation 622 may be performed.

At 620, one or more of the modules 120, 202 may determine whether the timer has exceeded a threshold (i.e., timed out). If yes, the method may end, otherwise operation 610 may be performed as shown or operation 612 may be performed.

At 622, one or more of the modules 120, 204 may perform a vehicle operation that can be detected by the user similar to above operation 610. This vehicle operation may be done as part of a user challenge and in response to which the user will be requested to provide an input response. In an embodiment, operation 622 is not performed and operation 624 is performed instead.

At 624, one or more of the modules 120, 204 sends a challenge request from the vehicle 102 to the mobile smart device 106. Operations 700, 710, 718, 720, 722, 724 may then be performed by the mobile smart device 106.

At 626, one or more of the modules 120, 204 receives a response signal indicating a user input response and details thereof. This may include raw sensor data, filtered sensor data, and/or translated (or processed) sensor data.

At 627, one or more of the modules 120, 204 may initiate a second timer if not already started.

At 628, one or more of the modules 120, 204 determines, based on the response signal including the user input response and details thereof, whether the user's response is valid. If the received data does match the expected response for continuing operations for the SPAA, then operation 630 may be performed, otherwise operation 632 may be performed.

At 630, one or more of the modules 120, 204 determines whether the SPAA has completed the operations to be performed (e.g., the parking of the vehicle 102, the removing (pulling out) of the vehicle 102 from a parking space, the opening or closing of a liftgate or tailgate, the opening or closing of a convertible top, etc.). If yes, the method may end, otherwise operation 622 may be performed as shown or operation 624 may be performed.

At 632, one or more of the modules 120, 204 determines whether the second timer has exceeded a threshold (or timed out). If not, operation 622 or 624 may be performed, otherwise the method may end.

FIG. 7 shows a challenge request transfer method implemented by the mobile smart device 106 of FIGS. 1 and 3. At least a portion of the following operations are iteratively performed. The following operations may be performed by one or more of the modules 300, 302 of FIG. 3.

At 700, the control module 300 determines whether a challenge request has been received from the vehicle 102. If no, operation 702 may be performed, otherwise operation 710 may be performed.

At 702, one or more of the modules 300, 302 determines whether a signal has been received from the vehicle 102 to obtain confirmation to continue performing SPAA operations. If yes, operation 704 may be performed, otherwise operation 700 may be performed.

At 704, one or more of the modules 300, 302 requests a confirmation input from the user of the mobile smart device 106 to continue SPAA operations. This may include for example providing a request message on the display 304 and/or some other type of visual and/or audible request message.

At 706, one or more of the modules 300, 302 receives a confirmation input response from the user. The display 304, microphone 306, and/or sensors 308 may detect and/or receive the user response. In an embodiment, the mobile smart device 106 may determine if the response is valid for continued SPAA operations.

At 708, one or more of the modules 300, 302 transmits a response signal to the vehicle 102 indicating whether a valid confirmation response was received from the user. Operation 700 may be performed after operation 708.

At 710, one or more of the modules 300, 302 determines whether a challenge request has been received from the vehicle for an initial confirmation. If yes, operation 712 may be performed, otherwise operation 718 may be performed.

At 712, one or more of the modules 300, 302 indicates challenge request to user of mobile smart device 106. This may be indicated using various different techniques including: displaying images, commands and/or questions on the display 304 of the mobile smart device 106; providing audible commands, messages and/or questions; illuminating buttons on the mobile smart device 106 and asking the user to press the buttons lit up; requesting the user press certain number on the display 304; etc. Other examples are described herein.

At 714, one or more of the modules 300, 302 detects user input in response to challenge request. At 716, one or more of the modules 300, 302 transmits signal indicating detected user input and details thereof to vehicle 102. This may include raw sensor data, filtered sensor data, and/or translated (or processed) sensor data.

At 718, one or more of the modules 300, 302 indicates challenge request to user of mobile smart device 106. At 720, one or more of the modules 300, 302 detects user input in response to challenge request. At 722, one or more of the modules 300, 302 transmits signal indicating detected user input and details thereof to vehicle 102. This may include raw sensor data, filtered sensor data, and/or translated (or processed) sensor data.

At 724, one or more of the modules 300, 302 determines whether another challenge request has been received. If yes, operation 718 may be performed, otherwise the method may end.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The above-stated examples allow a requestor (e.g., a vehicle) to have active participation in user's interaction with a mobile smart device. The vehicle is able to monitor remote user actions with the mobile smart device and validate these actions locally at the vehicle. The examples eliminate issues associated with mobile smart device and/or application thereof not correctly validating user inputs. The modules at the vehicle performing the monitoring such as the vehicle control module and user presence module may be implemented as automotive safety integrity level components and/or modules.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system comprising:
a transceiver;
a vehicle module configured to execute a supervised partially autonomous application (SPAA) at a vehicle;
a user interface system configured to receive an input from a user to initiate a supervised remote mode for user presence control during execution of the SPAA; and
a user presence module configured, until SPAA operations are ceased or completed, to perform a user presence process including iteratively i) transmitting a challenge request signal from the vehicle to a mobile smart device via the transceiver, ii) based on the challenge request signal, receiving a response signal from the mobile smart device indicating a user response provided to the mobile smart device, iii) based on the response signal, confirming user presence and whether the user response is valid for continued execution of operations of the SPAA, and iv) based on validation of the user response, performing a next operation of the SPAA.

2. The vehicle system of claim 1, wherein the user presence module is configured, subsequent to initiating operation in the supervised remote mode and prior to performing operations of the SPAA, to perform a confirmation process including i) transmitting a second challenge request signal to the mobile smart device for confirmation to execute the SPAA, ii) based on the second challenge request signal, receiving another response signal from the mobile smart device indicating a user response provided to the mobile smart device, iii) based on the another response signal, confirming user presence and whether the user response is valid to execute the SPAA, and iv) based on validation of the user response, at least one of performing an operation of the SPAA and performing the user presence process.

3. The vehicle system of claim 2, wherein the user presence module is configured to:
start a timer when the second challenge request signal is transmitted to the mobile smart device;
in response to the timer timing out prior to user presence being confirmed and the user response being validated to execute the SPAA, refraining from performing operations of the SPAA; and
in response to confirming user presence and validation of the user response to execute the SPAA, permitting performance of operations of the SPAA.

4. The vehicle system of claim 1, wherein the user presence module is configured, subsequent to initiating operation in the supervised remote mode and prior to performing operations of the SPAA, to perform a confirmation process including i) transmitting a confirmation request signal to the mobile smart device for confirmation to execute the SPAA, ii) based on the confirmation request signal, receiving another response signal from the mobile smart device indicating a user response has been received at the mobile smart device and the user response has been validated for execution of the SPAA, and iii) based on the another response signal, at least one of performing an operation of the SPAA and performing the user presence process.

5. The vehicle system of claim 4, wherein the user presence module is configured to:
start a timer when the confirmation request signal is transmitted to the mobile smart device;
in response to the timer timing out prior to receiving confirmation from the mobile smart device to execute the SPAA, refrain from performing operations of the SPAA; and
in response to receiving confirmation from the mobile smart device to execute the SPAA, permit performance of operations of the SPAA.

6. The vehicle system of claim 1, wherein the user presence process is performed subsequent to initiation of the supervised remote mode and subsequent to detecting that the user has exited the vehicle.

7. The vehicle system of claim 1, wherein the challenge request signal includes a request for the user to at least one of provide a gesture, perform a physical action, provide an audible input, answer a question, and perform a requested task including interaction with the mobile smart device.

8. The vehicle system of claim 1, wherein the SPAA is at least one of a supervised remote parking application, a supervised remote liftgate application, a supervised remote tailgate application, a supervised remote convertible top application, and supervised remote safety critical application.

9. The vehicle system of claim 1, wherein the user presence module is configured to:
start a timer when the challenge request signal is transmitted to the mobile smart device;
in response to the timer timing out prior to user presence being confirmed and the user response being validated, refrain from performing operations of the SPAA; and
in response to confirming user presence and validation of the user response, permit performance of operations of the SPAA.

10. The vehicle system of claim 1, wherein the vehicle module is configured to, during at least one of confirmation to execute the SPAA and execution of the SPAA, ignore signals received from a second mobile smart device paired with the vehicle that are directed to the SPAA.

11. A mobile smart device comprising:
a transceiver configured to receive challenge request signals from a vehicle for performing operations of a supervised partially autonomous application (SPAA) at the vehicle; and
a control module configured to perform an iterative transfer process for validation of user responses to the challenge request signals, the iterative transfer process comprising iteratively
based on a respective one of the challenge request signals, indicating a challenge request to a user of the mobile smart device,
detecting a user response to the challenge request, and
transmitting a response signal indicating the user response to the vehicle without validating the user response for continued execution of the SPAA.

12. The mobile smart device of claim 11, wherein the control module is configured to, prior to performing the iterative transfer process:
receive another challenge request signal from the vehicle requesting confirmation to execute the SPAA;
based on the another challenge request signal requesting confirmation to execute the SPAA, indicate a challenge request to the user;
detect a user response to the another challenge request signal requesting confirmation to execute the SPAA; and
transmit a response signal indicating the user response to the vehicle without validating the user response for continued execution of the SPAA.

13. The mobile smart device of claim 11, further comprising sensors for detecting the user responses to the challenge requests, wherein the sensors are configured to detect at least one of physical actions taken by the user to provide the user response, audible actions taken by the user to provide the user response, and input responses provided by the user to provide the user response.

14. The mobile smart device of claim 11, wherein the control module is configured to, prior to performing the iterative transfer process:
receive a confirmation request signal from the vehicle requesting confirmation to execute the SPAA;
based on the confirmation request signal requesting confirmation to execute the SPAA, request confirmation from the user to execute the SPAA;
detect a user response to the request;
confirm that the user response to the request is valid; and
transmit a response signal indicating that a user response has been received and validated for confirmation to execute the SPAA.

15. A user presence control method comprising:
receiving an input from a user within a vehicle to initiate a supervised remote mode for user presence control during execution of a supervised partially autonomous application (SPAA); and
until SPAA operations are ceased or completed, to perform a user presence process including iteratively i) transmitting a challenge request signal from the vehicle to a mobile smart device via a transceiver, ii) based on the challenge request signal, receiving a response signal from the mobile smart device at the vehicle indicating a user response provided to the mobile smart device, iii) based on the response signal, confirm user presence and whether the user response is valid for continued execution of operations of the SPAA, and iv) based on validation of the user response, perform a next operation of the SPAA.

16. The user presence control method of claim 15, further comprising, subsequent to initiating operation in the supervised remote mode and prior to performing operations of the SPAA, performing a confirmation process including i) transmitting a second challenge request signal to the mobile smart device for confirmation to execute the SPAA, ii) based on the second challenge request signal, receiving another response signal from the mobile smart device indicating a user response provided to the mobile smart device, iii) based on the another response signal, confirming user presence and whether the user response is valid to execute the SPAA, and iv) based on validation of the user response, at least one of performing an operation of the SPAA and performing the user presence process.

17. The user presence control method of claim 16, further comprising:
starting a timer when the second challenge request signal is transmitted to the mobile smart device;
in response to the timer timing out prior to user presence being confirmed and the user response being validated to execute the SPAA, refraining from performing operations of the SPAA; and
in response to confirming user presence and validation of the user response to execute the SPAA, permitting performance of operations of the SPAA.

18. The user presence control method of claim 15, further comprising, subsequent to initiating operation in the supervised remote mode and prior to performing operations of the SPAA, performing a confirmation process including i) transmitting a confirmation request signal to the mobile smart device for confirmation to execute the SPAA, ii) based on the confirmation request signal, receiving another response signal from the mobile smart device indicating a user response has been received at the mobile smart device and the user response has been validated for execution of the SPAA, and iii) based on the another response signal, at least one of performing an operation of the SPAA and performing the user presence process.

19. The user presence control method of claim 18, further comprising:
starting a timer when the confirmation request signal is transmitted to the mobile smart device;
in response to the timer timing out prior to receiving confirmation from the mobile smart device to execute the SPAA, refraining from performing operations of the SPAA; and
in response to receiving confirmation from the mobile smart device to execute the SPAA, permitting performance of operations of the SPAA.

20. The user presence control method of claim 15, wherein the SPAA is a supervised remote parking application, a liftgate application, a tailgate application, or a convertible top application.
